(19) United States
(12) Patent Application Publication
(10) Pub. No.: US 2006/0127624 A1
(43) Pub. Date: Jun. 15, 2006

(54) Reminder note sheet with an attachment mechanism

(76) Inventor: Donald L. White, Oconomowoc, WI (US)

Correspondence Address: QUARLES & BRADY LLP, 411 E. WISCONSIN AVENUE, SUITE 2040, MILWAUKEE, WI, 53202-4497, US

(21) Appl. No.: 11/009,306

(22) Filed: Dec. 10, 2004

(51) Int. Cl. B32B 33/00

(52) U.S. Cl. 428/40.1; 428/99

(57) ABSTRACT

A reminder system includes a note sheet that has a first area on which a promotional or inspirational message is preprinted and a second area adapted for a person to write a message related to a future event in which the person is to participate. A connector passes through the aperture for securing the note sheet to an object used by the person.

### STATEMENT REGARDING FEDERALLY SPONSORED RESEARCH OR DEVELOPMENT

Not Applicable

### CROSS-REFERENCE TO RELATED APPLICATIONS

Not Applicable

### BACKGROUND OF THE INVENTION

1. Field of the Invention

The present invention relates to note systems by which a person can write a reminder for a given event, and more particularly to a reminder system that provides a connector for attaching a note sheet to an object that is to be carried by the person.

2. Description of the Related Art

When a person has an upcoming event, such as an errand to run, a task to perform, or a someone to contact, for example, the person often writes a note to herself or himself that provides a reminder of the upcoming event. The note typically is written on a piece of paper which is placed in a prominent place so that the person will observe the note frequently enough to be reminded of the event. Often times, however, the piece of paper on which the reminder is written becomes misplaced or covered up, thereby no longer reminding the person of the event.

In order to avoid misplacing the note paper, the reminder is written on self-adhering paper which is then placed on an object so that the reminder is prominently displaced to the person. Usually the object is something that the person will use sometime prior to the event related to the reminder. For example, the note containing the reminder message may be adhered to a briefcase or purse of the individual who has an errand to run on the way home from work.

Although self-adhering paper can be applied to a wide variety of objects, some objects do not lend themselves to the application of such reminder notes. For example, it may be difficult to apply such a note to clothing, such as an outer coat that the person will put on before leaving the workplace. Thus, other forms of attachment are desired.

### SUMMARY OF THE INVENTION

A reminder system comprises a note sheet having a first area and a second area. The supplier of the note sheet has printed one of a promotional message and an inspirational message on the first area. The second area is adapted for a person to write a message related to a future event in which the person is to participate. The note sheet has an aperture there through. A connector passes through the aperture for securing the note sheet to an object used by the person. The connector is a carabiner, for example, that has a closure mechanism that prevents the note sheet from being inadvertently removed from the object or lost.

The person uses the reminder system by handwriting a message in the second area of the note sheet. That message provides a reminder on a future event for that person. The connector then is employed to attached the note sheet to an object, such as a briefcase, a key ring, a purse or an article of clothing used by the person. Thus when the person subsequently observes or goes to use the object, he or she will be reminded of the event.

### BRIEF DESCRIPTION OF THE DRAWINGS

FIG. 1 illustrates a reminder system, according to the present invention, which contains a preprinted promotional message of a company that supplied the reminder notes;

FIG. 2 shows the reverse side of the note sheet in FIG. 1 on which a handwritten reminder may be recorded;

FIG. 3 depicts a pad of note sheets; and

FIG. 4 illustrates an alternative S-hook type connector that may be used in the reminder system.

### DETAILED DESCRIPTION OF THE INVENTION

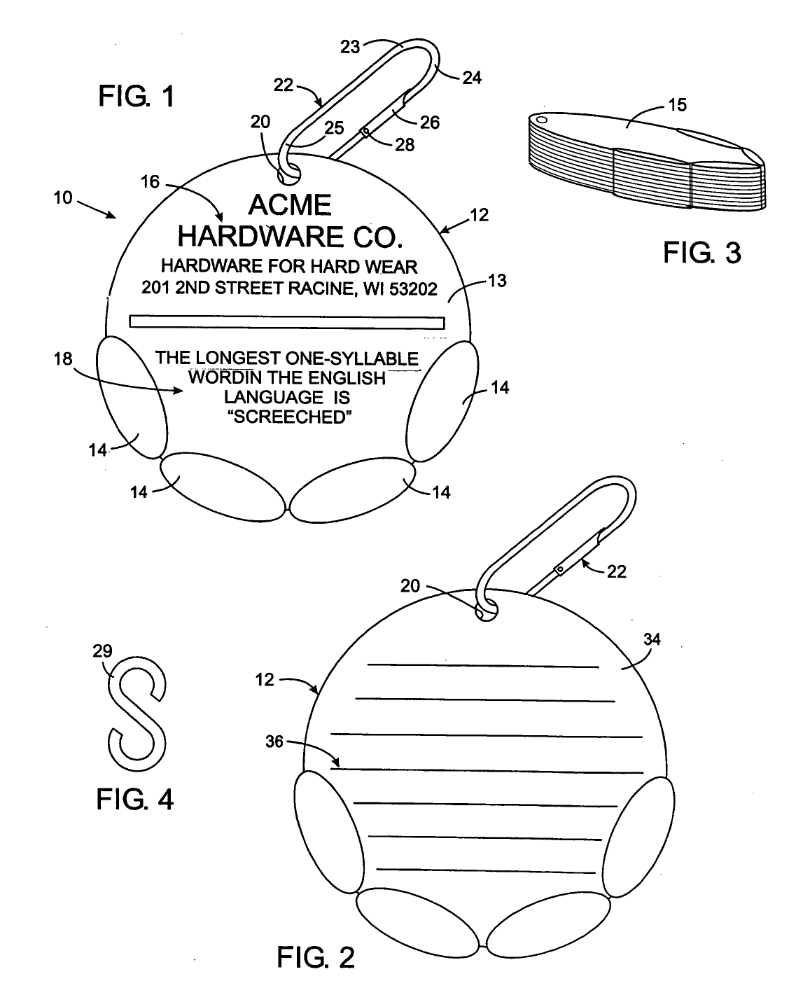

With initial reference to FIG. 1, a reminder system 10 comprises a note sheet 12 having a generally circular shape that appears as a foot print of an elephant with four toe nails 14. The reminder system 10 is exemplary of a promotional item which can be handed out free to customers and prospective customers in order to promote a company's business. To that end, a first area 16 on one surface 13 of the note sheet 12 has a promotional message, in this case, identifying the company that handed out the article. In other cases, the promotional message in area 16 can be related to a particular product of that company. The one surface 13 has a region 18 containing a preprinted clever saying, item of trivia, or an inspirational message.

FIG. 2 shows the opposite second surface 34 of the note sheet 12. The second area 36 is void of any printed messages so as to provide an area in which the user of the message system can write a reminder message. For example, the reminder message may relate to a task that the person has to perform in the future, an errand to be run, a person to contact, items to purchase, and the like. A pen, pencil, or other writing instrument can be used to write the message in this second area 36.

The note sheet 12 is commonly supplied as a stack 15 of note sheets as shown in FIG. 3. The stack may be kept as individual sheets in tray-like holder or may be bound by adhesive along part of its edge to form a pad. Each note sheet 12 may be formed from paper, a synthetic paper made from a thermoplastic film, such as products made with Tyvek® high-density polyethylene fiber produced by E. I. du Pont de Nemours and Company, or other materials that can be written upon.

The note sheet 12 has a small aperture 20 along the edge for receiving a connector 22, such as a carabiner. The connector 22 has a loop of a rigid metal or plastic rod 24 with a gap that is bridged by a closure device 26. Specifically the rod 24 forms a first hook 23 and a second hook 25 that passes through the aperture 20 in the note sheet. As is common with carabiners, the closure device 26 is a small tube that is pivotally connected by pin 28 to one end of the rod 24 and spring loaded so as to bridge both ends of the gap in the loop. A person is able to pivot the closure device 26 inward with respect to the loop, to expose one end of the rod to insert the connector 22 through the aperture 20 in the note sheet 12, as well as to secure the connector to another object. Upon being released, the closure device 26 springs back into the illustrated position to close the gap in the connector loop and thereby inhibit the reminder note sheet 12 from being inadvertently removed from the object. FIG. 4 depicts an S-hook connector 29 that can be used in place of the carabiner. Various other connectors can be used with the note sheet 12.

For example, the connector 22 can be used to attach a note sheet 12 to the handle of a briefcase, a key ring or the strap of a purse. The connector 22 also can be inserted through a button hole in an item of apparel, behind the button on a coat or jacket, or onto a belt loop of a pair of pants. Such attachment of the connector secures the note sheet 12 to an article so as to remind the user of the article of the event written in area 18. Thus, the connector enables the reminder note sheet 12 to be attached to a wide variety of objects which would normally be carried or worn by the person.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A reminder system comprising;
a note sheet having a first area on which a supplier of the note sheet has printed one of a promotional message and an inspirational message, and a second area adapted for a person to write a personal message related to a future event in which the person to participate, and the note sheet having an aperture there through; and
a connector passing through the aperture for securing the note sheet to an object used by the person.

2. The reminder system as recited in claim 1 wherein the connector comprises a carabiner.

3. The reminder system as recited in claim 1 wherein the connector comprises a first hook section that passes through the aperture in the note sheet and a second hook section for engaging the object.

4. The reminder system as recited in claim 3 wherein the connector further comprises a releasable closure device extending between the first hook section and the second hook section to prevent inadvertent removal of the note sheet from the object.

5. The reminder system as recited in claim 1 wherein the note sheet has a shape of an elephant foot print.

6. The reminder system as recited in claim 1 further comprising a plurality of other note sheets placed into a stack.

7. The reminder system as recited in claim 1 further comprising a plurality of other note sheets bonded together in a pad.

8. The reminder system as recited in claim 1 wherein in note sheet comprises synthetic paper made from a thermoplastic film.

9. A method for reminding a person of a future event in which the person is to participate, said method comprising:
providing a note sheet having a first area on which a supplier of the note sheet has printed a promotional message and an inspirational message, a second area, and an aperture there through;
writing a message related to a future event on the note sheet in the second area; and
employing a connector, that passes through the aperture, to secure the note sheet to an object used by the person.
